(19) United States
(12) Patent Application Publication
(10) Pub. No.: US 2025/0122857 A1
(43) Pub. Date: Apr. 17, 2025

(54) START CONTROL DEVICE FOR INTERNAL COMBUSTION ENGINE

(71) Applicant: TOYOTA JIDOSHA KABUSHIKI KAISHA, Toyota-shi (JP)

(72) Inventor: Masashi MIZUNO, Ichinomiya-shi (JP)

(73) Assignee: TOYOTA JIDOSHA KABUSHIKI KAISHA, Toyota-shi (JP)

(21) Appl. No.: 18/664,545

(22) Filed: May 15, 2024

(30) Foreign Application Priority Data
Oct. 17, 2023 (JP) 2023-179067

(51) Int. Cl. F02N 11/08

(52) U.S. Cl. CPC F02N 11/0851; F02N 2200/02

(57) ABSTRACT

A control device for starting an internal combustion engine by outputting torque from an electric motor connected to a torque transmission path from an internal combustion engine to a drive wheel so as to be capable of transmitting torque, wherein a pulsating component of a reaction force torque generated by starting the internal combustion engine is obtained, and a pulsating component of a torque input to the compositing position is obtained on the basis of a spring constant, a damping coefficient, and a moment of inertia of a power transmission member between a compositing position where torque is transmitted from the electric motor to the torque transmission path and the internal combustion engine, and a pulsating component of the reaction force torque, and an AC component torque and a cranking torque are added to determine a torque command value of the electric motor when starting the internal combustion engine.

### CROSS-REFERENCE TO RELATED APPLICATION

This application claims priority to Japanese Patent Application No. 2023-179067 filed on Oct. 17, 2023, incorporated herein by reference in its entirety.

### BACKGROUND

### 1. Technical Field

The disclosure relates to a control device for starting an internal combustion engine by motoring the internal combustion engine by transmitting torque from an electric motor to the internal combustion engine.

### 2. Description of Related Art

Japanese Unexamined Patent Application Publication No. 2016-203809 (JP 2016-203809 A) describes a hybrid electric vehicle. In this hybrid electric vehicle, an engine is connected to a carrier in a single-pinion planetary gear mechanism. A first motor is connected to a sun gear. An intermediate shaft is connected to a ring gear. Drive wheels are connected to an output side of the intermediate shaft, via a transmission mechanism that is capable of setting a plurality of gear stages including neutral. This hybrid electric vehicle is configured such that the transmission mechanism can set a traveling range and a non-traveling range by setting a predetermined gear stage. In the traveling range, the intermediate shaft and the drive wheels are connected to each other so as to be capable of transmitting torque. In the non-traveling range, the intermediate shaft and the drive wheels are disengaged by the transmission mechanism being in the neutral state. JP 2016-203809 A describes a start control device configured to switch start control of the engine based on these traveling ranges.

The start control device is configured to output a cranking torque from the first motor, for motoring the engine. When the traveling range is set, a torque command value of the first motor is set to a value obtained by adding a vibration suppression torque, which is in-phase with a pulsating component of engine torque, to the cranking torque for motoring the engine. Also, when the non-traveling range is set, the torque command value of the first motor is set to a value obtained by adding a vibration suppression torque, which is opposite phase to the pulsating component of the engine torque, to the cranking torque.

Japanese Unexamined Patent Application Publication No. 2019-119405 (JP 2019-119405 A) describes a hybrid electric vehicle. In this hybrid electric vehicle, an engine is connected to a carrier in a single-pinion planetary gear mechanism. A first motor is coupled to a sun gear. Drive wheels are connected to a ring gear via a gear train. Further, a second motor is connected to the gear train so as to be capable of transmitting torque. This hybrid electric vehicle includes a start control device. This start control device is also configured to output cranking torque and vibration suppression torque from the first motor to perform motoring of the engine, similar to the start control device described in JP 2016-203809 A. Hereinafter, the start control device described in JP 2019-119405 A will be described. The start control device is configured to construct an equation of motion. An equation of motion is an equation of motion for a one-dimensional moment of inertia in a torsional direction of a drive shaft, with respect to resonance of a damper provided between the engine and the carrier, resonance of the drive shaft, and resonance of a suspension system of the engine. The start control device is configured to calculate each resonant frequency in a coupled state, based on the equation of motion. The start control device is configured to compute an execution torque pulsation map, by subtracting a resonance component at each resonance frequency from a torque pulsation map. The start control device is configured to compute the vibration suppression torque, using the execution torque pulsation map.

### SUMMARY

The start control device described in JP 2016-203809 A determines a torque command value of the first motor by adding a vibration suppression torque, which is in-phase or opposite-phase with respect to the pulsating component of the engine torque mapped in advance, to the cranking torque. However, the pulsating component of the engine torque fluctuates due to torsion, inertia, and so forth of members making up a power transmission path between the engine and the first motor. Accordingly, even when the vibration suppression torque which is in-phase or opposite-phase with respect to the pulsating component is output from the first motor, there is a possibility that the phase will not agree with the torque transmitted from the engine at the portion where the torque of the first motor is composited, and vibration suppression will not be able to be sufficiently performed.

Also, the start control device described in JP 2019-119405 A is configured to reduce pulsation of torque at the point in time that the torque is transmitted from the engine to the drive wheels, and accordingly output torques of the first motor and the second motor are controlled cooperatively. Accordingly, when performing such cooperative control, control delay of the first motor and control delay of the second motor need to be taken into consideration, and there is a possibility that control will become complicated.

The disclosure has been made in light of the above technical issues, and it is an object thereof to provide a start control device for an internal combustion engine that is capable of easily reducing pulsation of torque transmitted from the internal combustion engine, by an electric motor.

In order to achieve the above object, the disclosure is a start control device for an internal combustion engine, in which an electric motor is connected to a torque transmission path from the internal combustion engine to a drive wheel, such that the electric motor is arranged to transmit torque to the torque transmission path, and the internal combustion engine is started by torque being output from the electric motor.

The start control device includes a controller for controlling the electric motor.
The controller is configured to
find a pulsating component of a reaction force torque generated by starting the internal combustion engine,
find, based on a parameter that is at least one of a spring constant, a damping coefficient, and a moment of inertia, regarding a power transmission member between a compositing position at which the torque is transmitted from the electric motor to the torque transmission path and the internal combustion engine, and the pulsating component of the reaction force torque, the pulsating component of the torque input to the compositing position, and determine a torque command value of the electric motor for starting the internal combustion engine, by adding an alternating current (AC) component torque in accordance with the pulsating component of the torque input to the compositing position and a cranking torque required for motoring the internal combustion engine.

In the disclosure, the power transmission member may include a damper mechanism that reduces pulsation of torque of the internal combustion engine and outputs the torque with reduced pulsation, and a torque transmission shaft that transmits torque from the internal combustion engine to the compositing position.

In the disclosure, the controller may include a map for finding the AC component torque based on a rotational angle of a crankshaft of the internal combustion engine.

In the disclosure, the start control device may further include a differential mechanism made up of a first rotating element to which torque is transmitted from the internal combustion engine, a second rotating element to which torque is transmitted from the electric motor, and a third rotating element connected to the drive wheel so as transmit torque to the drive wheel, and another electric motor that is connected to a transmission path of the torque between the third rotating element and the drive wheel.

According to the disclosure, the pulsating component of the torque input to the compositing position is found based on at least one parameter of the spring constant, the damping coefficient, and the moment of inertia of the power transmission member, and the pulsating component of the reaction force torque. The power transmission member is disposed between the compositing position where torque is transmitted from the electric motor, and the internal combustion engine. The pulsating component of the reaction force torque is generated by starting the internal combustion engine. The torque command value of the electric motor is determined by adding the AC component torque corresponding to the pulsating component of the torque input to the compositing position, and the cranking torque required for motoring the internal combustion engine. By determining the torque command value of the electric motor in this way, pulsation of the torque can be reduced in the process of transmitting the torque from the internal combustion engine to the drive wheels. Also, the torque command value for reducing the pulsation of the torque can be determined based on the pulsation of the reaction force torque accompanying starting of the internal combustion engine, and the spring constant, the damping coefficient, or the moment of inertia determined by the structure of the power transmission member that transmits the torque. Accordingly, the pulsation of the torque input to the compositing position can be determined in advance, and accordingly the torque command value can be determined by feedforward control, whereby control can be simplified.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an exemplary hybrid electric vehicle equipped with an internal combustion engine according to an embodiment of the present disclosure;

FIG. 2 is a diagram illustrating a change in reaction force torque generated during motoring of an engine;

FIG. 3 is a flowchart for explaining an example of control executed by the start control device according to the embodiment of the present disclosure;

FIG. 4 is a diagram illustrating an exemplary vibration suppression map illustrating a relation between a torque inputted from an engine to a carrier and a crank angle; and

FIG. 5 is a time chart for explaining changes in the engine speed, the crank angle, the torque (input torque) input from the engine to the carrier, the vibration suppression gain, and AC component torque of the first motor at the time of starting the engine.

### DETAILED DESCRIPTION OF EMBODIMENTS

The present disclosure will be described based on an embodiment shown in the drawings. Note that the embodiments described below are merely examples of a case where the present disclosure is embodied, and the present disclosure is not limited thereto.

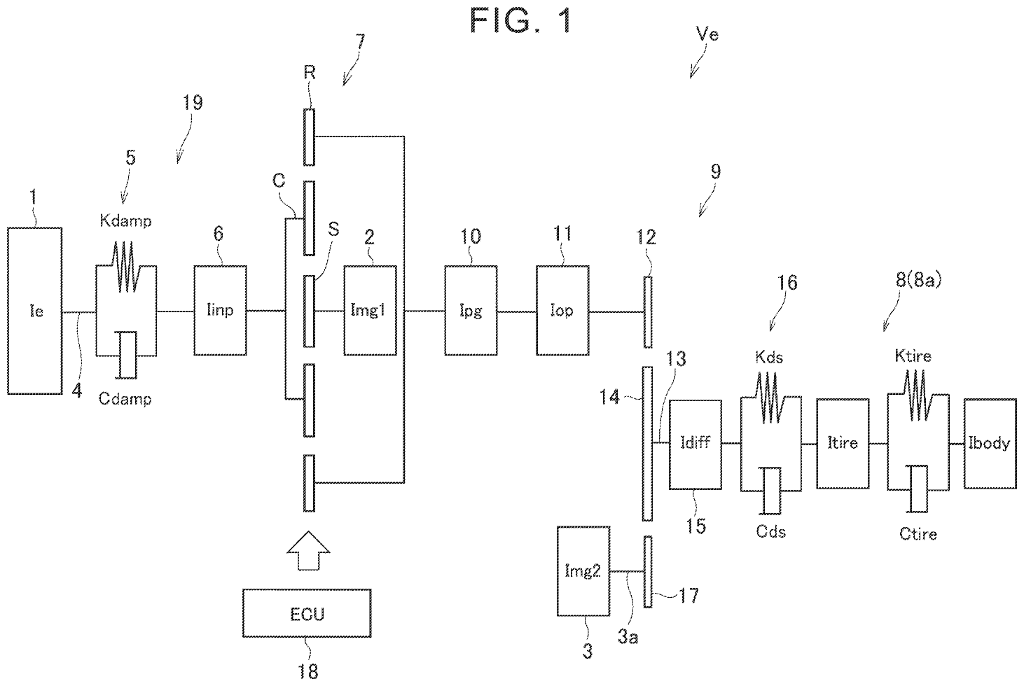

FIG. 1 is a diagram illustrating an exemplary hybrid electric vehicle including an internal combustion engine (hereinafter, referred to as an engine) according to an embodiment of the present disclosure. Hybrid electric vehicle (hereinafter, simply referred to as vehicle) Ve shown in FIG. 1 includes an engine 1, a first motor 2, and a second motor 3 as driving force sources.

The engine 1 shown in FIG. 1 can be configured similarly to a conventional gasoline engine or diesel engine. That is, a plurality of cylinders (not shown), a piston that reciprocates inside the cylinders, and a connecting rod that transmits a load to be reciprocated by the piston as a torque of the crankshaft 4 which is an output shaft are provided. The engine 1 can also be configured with a 4-stroke engine that performs an intake stroke, a compression stroke, a combustion stroke, and an exhaust stroke. In the intake stroke, air is sucked into the cylinder. In the compression stroke, the air-fuel mixture in the cylinder is compressed. During the combustion stroke, the air-fuel mixture burns. In the exhaust stroke, the exhaust gas generated by the combustion of the air-fuel mixture is discharged from the cylinder.

The first motor 2 and the second motor 3 can be configured similarly to a motor provided as a driving force source of a conventional hybrid electric vehicle. That is, in addition to a function as a motor that outputs a drive torque when power is supplied from a power storage device (not shown), the power storage device has a function as a generator that converts at least a part of the power into electric power when the output shaft is rotated together. Specifically, the rotor can be constituted by a synchronous motor provided with a permanent magnet, an induction motor, or the like.

A torsional damper 5 for reducing the pulsation of the torque of the engine 1 is connected to the crankshaft 4 of the engine 1. The torsional damper 5 can be configured in the same manner as a conventional torsional damper, and is configured to transmit torque from an input rotating member connected to the crankshaft 4 to an output rotating member via a spring that expands and contracts in a circumferential direction of the input rotating member. In FIG. 1, the spring constant of the torsional damper 5 is referred to as “Kdamp”, and the damping coefficient of the torsional damper 5 is referred to as “Cdamp”. The torsional damper 5 corresponds to a “damper mechanism” in the embodiment of the present disclosure.

A power split mechanism 7 is connected to the output rotation member of the torsional damper 5 via an input shaft 6. In FIG. 1, the moment of inertia of the input shaft 6 is referred to as “Iinp”. The input shaft 6 corresponds to a “torque transmission shaft” in the embodiment of the present disclosure.

The power split mechanism 7 can be configured by a differential mechanism that divides the torque of the engine 1 into the first motor 2 and the drive wheels 8. The power split mechanism 7 shown in FIG. 1 is constituted by a single pinion type planetary gear mechanism. In the power split mechanism 7, the first motor 2 is connected to the sun gear S, the input shaft 6 is connected to the carrier C, and the drive wheels 8 are connected to the ring gear R via a gear train portion 9, which will be described later. That is, when the drive torque is transmitted from the engine 1 to the drive wheels 8, the carrier C functions as an input element, the sun gear S functions as a reaction force element, and the ring gear R functions as an output element. In other words, the torque of the first motor 2 is combined with the torque output from the engine 1 by the power split mechanism 7, and the power split mechanism 7 corresponds to the “compositing position” in the embodiment of the present disclosure. Note that the carrier C corresponds to the “first rotating element” in the embodiment of the present disclosure, the sun gear S corresponds to the “second rotating element” in the embodiment of the present disclosure, and the ring gear R corresponds to the “third rotating element” in the embodiment of the present disclosure.

A parking gear 10 is formed on an outer peripheral surface of the ring gear R. In FIG. 1, the moment of inertia of the parking gear 10 is referred to as “Ipg” and is indicated on the output-side of the ring gear R for convenience.

In the example shown in FIG. 1, the output shaft 11 is connected to the ring gear R, and the drive gear 12 is connected to the output shaft 11. In FIG. 1, the moment of inertia of the output shaft 11 is referred to as “Iop”. A power transmission shaft 13 such as a propeller shaft is arranged in parallel with the output shaft 11 of the power split mechanism 7, and a driven gear 14 meshing with the drive gear 12 is attached to one end of the power transmission shaft 13. The driven gear 14 is formed to have a larger diameter than the drive gear 12, and the gear pair constitutes a reduction mechanism.

Drive wheels 8 are connected to the power transmission shaft 13 via a differential gear unit 15 and a pair of drive shafts 16. In FIG. 1, the moment of inertia of the differential gear unit 15 is referred to as “Idiff”. In FIG. 1, the spring constant of the drive shaft 16 is referred to as “Kds”, and the damping coefficient thereof is referred to as “Cds”. In FIG. 1, the moment of inertia of the tire 8a constituting the drive wheel 8 is referred to as “Itire”. In FIG. 1, the spring constant is referred to as “Ktire”, and the damping coefficient is referred to as “Ctire”. When the driving force changes due to the pulsation of the torque of the engine 1 or the like, the longitudinal acceleration of the vehicle body changes, and as a result, the occupant experiences vibration. Therefore, in the embodiment shown in FIG. 1, the moment of inertia corresponding to the weight of the vehicle body is referred to as “Ibody” on the output-side of the drive wheel 8 for convenience as a model for calculating the longitudinal acceleration of the vehicle body.

Further, in the example shown in FIG. 1, the torque of the second motor 3 can be combined at the portion of the driven gear 14. Specifically, the rotor shaft 3a of the second motor 3 is disposed parallel to the output shaft 11 and the power transmission shaft 13, and the output gear 17 meshing with the driven gear 14 is attached to the end portion in the rotor shaft 3a.

The above-described vehicle Ve is further provided with an electronic control unit (hereinafter referred to as an ECU) 18 for controlling the engine 1, the first motor 2, and the second motor 3. ECU 18 is mainly composed of a microcomputer as in an ECU provided in conventional vehicles. ECU 18 outputs a signal to the engine 1, the first motor 2, and the second motor 3 on the basis of an inputted signal and an arithmetic expression, a map, or the like stored in advance. This ECU 18 corresponds to the “controllers” in this embodiment.

ECU 18 is supplied with a signal. For example, an accelerator operation amount sensor that detects an operation amount of an accelerator pedal receives a signal from an ECU 18. For example, a vehicle speed sensor for detecting the vehicle speed receives a signal from ECU 18. For example, a crank angle sensor for detecting a crank angle of the engine 1 receives a signal from ECU 18. For example, the first resolver that detects the rotational angle of the first motor 2 receives a signal from ECU 18. For example, the second resolver that detects the rotational angle of the second motor 3 receives a signal from ECU 18. For example, an SOC sensor that detects the remaining charge level of the power storage device receives a signal from ECU 18. For example, signals are inputted to ECU 18 from a power storage device or a temperature sensor that detects the temperatures of the motors 2 and 3.

The vehicle Ve described above can set at least two travel modes: an engine travel mode in which the engine 1 is driven, and an EV travel mode in which the engine 1 is stopped and traveled by the power of the second motor 3. Further, even when the engine running mode is set, an idle stop control for stopping the engine 1 at the time of stopping the vehicle can be executed.

The engine running mode is a mode in which a part of the torque output from the engine 1 is transmitted to the drive wheels 8 and travels, and outputs a reaction force torque corresponding to the output torque of the engine 1 from the first motor 2. Further, the rotational speed of the first motor 2 is controlled so that the torque and the rotational speed of the engine 1 are changed on a predetermined optimum fuel efficiency line so that the engine 1 is driven at an operating point with good fuel efficiency. That is, the power split mechanism 7 functions as a continuously variable transmission that controls the rotational speed of the engine 1 by controlling the rotational speed of the first motor 2. When the first motor 2 functions as a generator when the reaction force torque is output from the first motor 2, the power generated by the first motor 2 is supplied to the second motor 3 as appropriate, so that the power of the second motor 3 can be added and traveled in the driven gear 14.

In EV driving mode, power corresponding to power required for vehicle Ve is outputted from the second motor 3. When the vehicle is traveling by outputting power from the second motor 3 as described above, the ring gear R of the power split mechanism 7 rotates at a rotational speed corresponding to the vehicle speed, the first motor 2 idles, and the engine 1 is stopped. This is because the inertia of the engine 1 is larger than the inertia of the first motor 2.

The vehicle Ve described above is configured to be able to switch between EV running mode and the engine running mode on the basis of the required driving force, the vehicle speed, the remaining charge amount of the power storage device, and the like. When the engine 1 is started to switch from EV running mode to the engine running mode, or when the idle stop control is ended and the engine 1 is started, the engine 1 is motorized (cranked) by the first motor 2. Specifically, by controlling the rotational speed of the first motor 2, the engine rotational speed is increased to a predetermined starting rotational speed. The first motor 2 corresponds to an “electric motor” in the embodiment of the present disclosure.

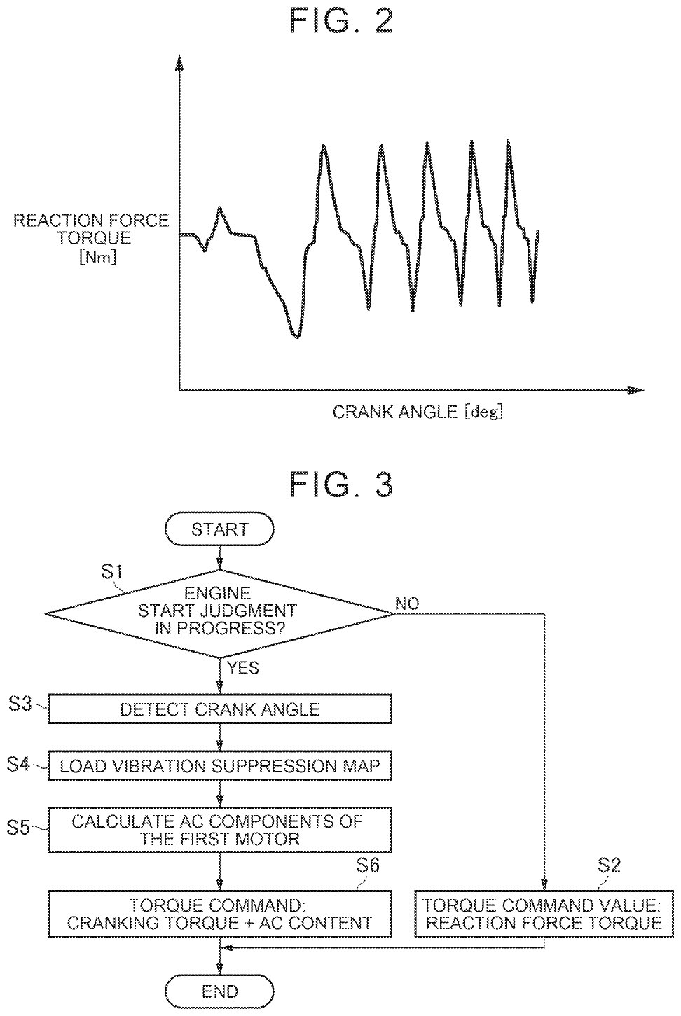

When the engine 1 is motored, the air in the cylinder is compressed as the piston rises, and thus the compression reaction force acts on the crankshaft 4. That is, the reaction force torque acting in the direction in which the rotation of the crankshaft 4 is stopped fluctuates in accordance with the rotation angle of the crankshaft 4. Further, in addition to the reaction force torque caused by the compression reaction force, a reaction force torque based on various resistance forces such as the sliding resistance between the piston and the cylinder bore also acts on the crankshaft 4, and the reaction force torque changes in accordance with the rotation angle of the crankshaft 4. That is, when the engine 1 is motored, the reaction force torque acts against the torque for the motoring, and the reaction force torque pulsates as shown in FIG. 2. In FIG. 2, the horizontal axis represents a crank angle (corresponding to time), and the vertical axis represents a reaction force torque.

On the other hand, since the torsional damper 5 and the input shaft 6 are provided between the engine 1 and the carrier C, the amplitude and frequency of the reaction force torque of the engine 1 fluctuate in accordance with the spring constant, the damping coefficient, and the like, and are input to the carrier C. The output torque of the first motor 2 is divided into a carrier C and a ring gear R, and the magnitude of the divided torque depends on the magnitude of the reaction force torque acting on the carrier C. Therefore, when a constant torque is output from the first motor 2, the torque output from the ring gear R pulsates as the reaction force torque input to the carrier C pulsates. Therefore, the start control device according to the embodiment of the present disclosure is configured to suppress the pulsation of the torque output from the ring gear R by pulsating the output torque of the first motor 2 in accordance with the magnitude of the reaction force torque input to the carrier C.

A flowchart for explaining an example of the control is shown in FIG. 3. In the exemplary control illustrated in FIG. 3, first, it is determined whether or not the engine start determination is being performed (S1). This S1 can be determined based on a flag indicating that it is a transient period to start the engine 1. For example, S1 turns on the engine start determination flag at a time point when the switching from EV running mode to the engine running mode is determined, or at a time point when the idle stop control is ended. For example, S1 turns off the flag at the time when the engine 1 reaches the complete explosion.

If a negative determination is made in S1 because the engine start determination is not in progress, the reaction force torque of the first motor 2 determined in accordance with the required driving force is outputted to the first motor 2 as the torque command value of the first motor 2 (S2), and the routine is temporarily ended. That is, the output torque of the engine 1 is obtained based on the required driving force. The reaction force torque of the first motor 2 is obtained by multiplying the output torque of the engine 1 by the gear ratio of the power split mechanism 7. The reaction force torque is outputted from ECU 18 to the first motor 2 as a torque command of the first motor 2.

On the contrary, when the determination is positive in S1 due to the engine start determination, the pulsation torque of the first motor 2 required to reduce the pulsation of the torque outputted from the ring gear R is determined. In the following explanation, the pulsation torque of the first motor 2 will be referred to as “AC component torque of the first motor”.

Specifically, first, the crank angle is detected (S3) and the vibration suppression map is read (S4). The vibration suppression map is constructed in advance by experimentation or simulations and stored in ECU 18. Specifically, first, as shown in FIG. 2, the relationship between the crank angle and the reaction force torque of the engine 1 is obtained by an experiment or a simulation. Next, the torque input to the carrier C is obtained on the basis of the reaction force torque of the pulsating engine 1 and parameters such as the spring constant, the damping coefficient, and the moment of inertia of the power transmission member 19. The power transmission member 19 is disposed between the engine 1, such as the torsional damper 5 and the input shaft 6, and the carrier C. Specifically, the torque input to the carrier C is obtained by the equation of motion shown in Equation (1).

$$To = T e - K θ - Cd θ / dt - I {d}^{2} θ / d {t}^{2} \qquad ( 1 )$$

To in Equation (1) is the torque inputted from the engine 1 to the carrier C. Te in Equation (1) is the torque of the engine 1. K in Equation (1) is the total spring constant of the power transmission member 19. C in Equation (1) is the total damping constant of the power transmission member 19. I in the Equation (1) is the total moment of inertia of the power transmission member 19. θ in Equation (1) is a torsion angle of the power transmission member 19.

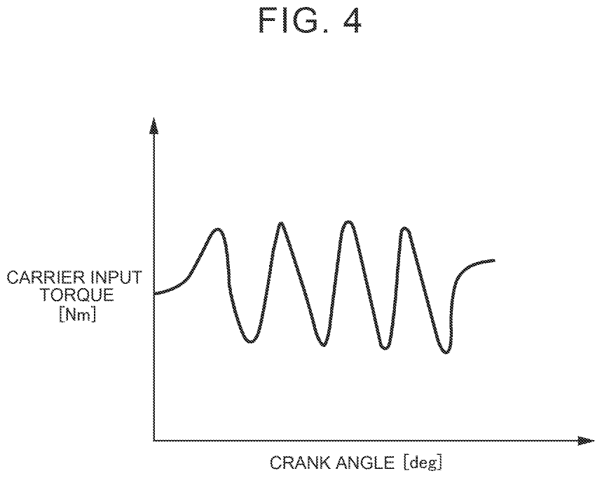

Then, the relation between the crank angle and the torque inputted to the carrier C is mapped and stored in ECU 18. FIG. 4 shows an example of a vibration suppression map showing the relationship between the torque input to the carrier C and the crank angle, wherein the horizontal axis represents the crank angle, and the vertical axis represents the torque transmitted to the carrier C.

Then, AC component torque of the first motor 2 is determined based on the crank angle detected by S3 and the vibration suppression map (S5). Specifically, AC component torque Tg of the first motor 2 is obtained so that the torque inputted from the engine 1 to the carrier C and the torque transmitted from the first motor 2 to the carrier C are equal to each other. That is, AC component torque Tg of the first motor 2 is obtained so that the pulsating component Tin of the combined torque obtained by combining the torque input to the carrier C and the torque input from the first motor 2 to the power split mechanism 7 becomes zero. That is, AC component-torque of the first motor 2 is obtained based on Equation (2).

$$Tin = T g - T o \qquad ( 2 )$$

Therefore, a torque having the same phase and the same magnitude as the torque inputted from the engine 1 to the carrier C is obtained as AC component torque Tg of the first motor 2. For convenience, the gear ratio of the power split mechanism 7 is set to “1”.

After S5, the torque obtained by adding AC component torque of the first motor 2 to the cranking torque required for motoring the engine 1 is outputted to the first motor 2 as the torque command value of the first motor 2 (S6), and this routine is temporarily ended. Since the rotational speed of the engine 1 becomes the resonant frequency of the power transmission member 19 in the low rotational speed range, a predetermined gain (vibration suppression gain) determined in advance in accordance with the rotational speed of the engine 1 may be multiplied by AC component torque of the first motor 2.

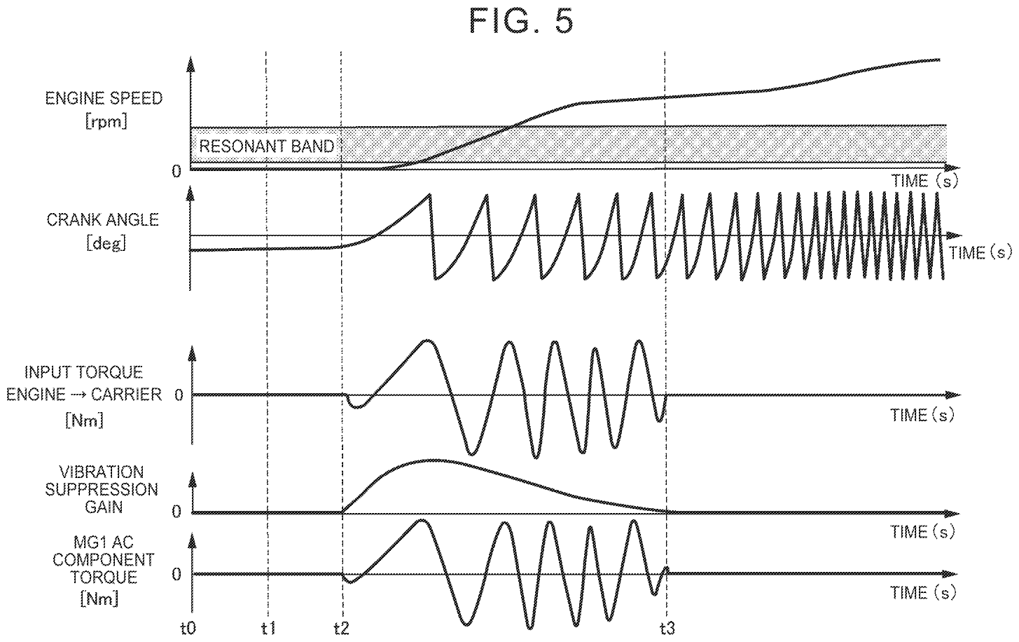

FIG. 5 is a time chart for explaining changes in the engine speed, the crank angle, the input torque, the vibration suppression gain, and AC component torque of the first motor 2 (MG1) at the time of starting the engine. The input torque in FIG. 5 is the torque input from the engine 1 to the carrier C. In order to facilitate the calculation of AC component torque of the first motor 2, the crank angle is set as a reference (zero) when the piston is at a predetermined position. The crank angle in which the piston is located on the upper side (compression side) of the reference position is indicated by a positive value, and the crank angle in which the piston is located on the lower side (expansion side) of the reference position is indicated by a negative value.

In the embodiment illustrated in FIG. 5, EV running mode is in progress at t0 time point, or the idle stop control is in progress, so that the engine 1 is stopped. Therefore, the engine speed is maintained at zero, the crank angle is maintained at a predetermined angle when the engine is stopped, and the incoming torque, the vibration suppression gain, and AC component torque of the first motor 2 are maintained at zero.

At t1 time point, the switching from EV running mode to the engine running mode is determined, or the end of the idle stop control is determined, and the engine 1 is required to be started. Therefore, at the time of t2, torque for cranking the engine 1 is outputted from the first motor 2. Specifically, a torque obtained by adding the cranking torque and AC component torque is outputted from the first motor 2. Cranking torque is the torque required for cranking the Engine 1. AC component torque is a torque required to suppress the pulsation of the reaction force torque generated when the engine 1 rotates. Therefore, as shown in FIG. 5, AC components torque of the first motor 2 and the pulsation of the torque inputted from the engine 1 to the carrier C are in the same phase.

By outputting torque from the first motor 2 in this way, the engine speed is gradually increasing. In addition, in the embodiment illustrated in FIG. 5, the vibration suppression gain corresponding to the rotational speed of the engine 1 is multiplied by AC component torque of the first motor 2. The vibration suppression gain is set to be maximum until the engine speed passes through a predetermined rotational speed band (resonance band).

Then, at t3 time point, the engine speed is increased to a predetermined speed, and the speed of the power transmission member 19 exceeds the resonant speed (frequency), so that the vibration suppression control by the first motor 2 is ended. That is, the addition of AC component torque to the torque command of the first motor 2 is stopped.

As described above, based on the spring constant, the damping coefficient, and the moment of inertia of the power transmission member 19 and the pulsating component of the reaction force torque generated by starting the engine 1, the pulsating component of the torque input from the engine 1 to the carrier C is obtained. Since AC component torque in the first motor 2 is determined in accordance with the pulsating component, the pulsation of the torque outputted from the ring gear R can be reduced.

Further, AC component torque of the first motor 2 can be determined based on the pulsation of the reaction force torque caused by starting the engine 1 and the spring constant, the damping coefficient, or the moment of inertia determined by the configuration of the power transmission member 19 that transmits the torque. Therefore, since the pulsation of the torque input to the carrier C can be determined in advance, the torque command value of the first motor 2 can be determined by the feedforward control, and the control can be simplified.

Further, when the engine 1 is started during traveling, braking torque is transmitted to the drive shaft 16 via the power split mechanism 7, and as a result, the drive shaft 16 may be twisted. However, when the torque for suppressing the torsion of the drive shaft 16 is output from the second motor 3, the vibration suppression control by the second motor 3 can be simplified. This is because by reducing the pulsation of the torque output from the ring gear R as described above, it is not necessary to consider the pulsating component of the torque transmitted to the drive shaft 16.

The internal combustion engine according to the embodiment of the present disclosure is not limited to the one connected to the differential mechanism such as the power split mechanism 7, and may be, for example, an internal combustion engine provided on an input side of a torque transmission path in which the electric motor and the transmission mechanism are connected in series. In this case, the pulsating component of the torque input to the position where the torque is transmitted from the electric motor may be obtained based on the spring constant, the damping coefficient, or the moment of inertia of the power transmission member provided between the internal combustion engine and the electric motor. Further, when the electric motor is connected in series as described above, AC component torque in the electric motor is a torque having a phase opposite to the pulsating component of the torque inputted to the position where the torque is transmitted from the electric motor. Thus, the pulsation of the torque on the output side of the electric motor can be reduced.

Further, in the above-described control example, an example in which the vibration suppression map is stored in ECU 18 in advance has been described, but the pulsating components of the torque inputted from the carrier C may be calculated and obtained at all times. Further, the power split mechanism 7 may be constituted by a double pinion type planetary gear mechanism, or may be constituted by a compound planetary gear mechanism in which a plurality of planetary gear mechanisms are appropriately connected by a clutch or the like.

1. (canceled)

2. The start control device according to claim 5, wherein
the power transmission member includes
a torsional damper configured to reduce pulsation of a torque of the internal combustion engine and output the torque of the internal combustion engine with the reduced pulsation, and
a torque transmission shaft configured to transmit the torque of the internal combustion engine with the reduced pulsation to the compositing-position component.

3. (canceled)

4. The start control device according to claim 5, wherein:
the compositing component is a differential mechanism including a first rotating element to which a torque generated by the internal combustion engine is transmitted, a second rotating element to which the torque generated by the electric motor is transmitted, and a third rotating element that is connected to the drive wheel and configured to transmit to the drive wheel a torque output from the first rotating element; and
another electric motor is connected to the torque transmission path between the third rotating element and the drive wheel.

5. A start control device for starting an internal combustion engine using a torque generated by an electric motor, the electric motor being connected to a torque transmission path between the internal combustion engine and a drive wheel, and the start control device comprising:
a memory that stores a vibration suppression map indicating a relation between crank angles of the internal combustion engine and corresponding compositing-position torques received by a compositing component from the internal combustion engine, the torque being transmitted to the torque transmission path via the compositing component; and
a processor configured to
determine whether the internal combustion engine is in a starting state,
detect a crank angle using a crank angle sensor in response to the determination that the internal combustion engine is in the starting state,
read out a compositing-position torque corresponding to the detected crank angle from the vibration suppression map,
determine a pulsating-component torque of the electric motor based on the read compositing-position torque,
calculate a combined torque by integrating the determined pulsating-component torque and a cranking torque required for motoring the internal combustion engine, and
send a torque command value to the electric motor to output the calculated combined torque, wherein
the vibration suppression map is generated by i) calculating the compositing-position torques for the respective crank angles by using one or more parameters of a power transmission member between the electric motor and the internal combustion engine in the torque transmission path and ii) subsequently mapping the calculated compositing-position torques to the respective crank angles, and
the one or more parameters include at least one of an engine torque, a spring constant, a damping coefficient, a moment of inertia, or a torsion angle.

6. The start control device according to claim 5, wherein the pulsating-component torque of the electric motor is determined to be equivalent to the read compositing-position torque.
